(19) United States
(12) Patent Application Publication
(10) Pub. No.: US 2022/0274163 A1
(43) Pub. Date: Sep. 1, 2022

(54) Three-Dimensional Printing

(71) Applicant: Hewlett-Packard Development Company, L.P., Spring, TX (US)

(72) Inventors: John Samuel Dilip Jangam, Palo Alto, CA (US); Kristopher Erickson, Palo Alto, CA (US); Thomas Craig Anthony, Palo Alto, CA (US); Lihua Zhao, Palo Alto, CA (US)

(73) Assignee: Hewlett-Packard Development Company, L.P., Spring, TX (US)

(21) Appl. No.: 17/637,635

(22) PCT Filed: Nov. 15, 2019
(86) PCT No.: PCT/US2019/061804

§ 371 Date: Feb. 23, 2022

(51) Int. Cl. B22F 1/105; B33Y 70/00; B33Y 10/00; B22F 10/14

(52) U.S. Cl. CPC B22F 1/105; B33Y 70/00; B33Y 10/00; B22F 10/14; B22F 2301/10

(57) ABSTRACT

The present disclosure relates to a method of three-dimensional (3D) printing a 3D printed metal object. The method comprises selectively jetting an alloying agent onto build material. The build material comprises a first metal and the alloying agent comprises an alloying component that forms an alloy with the first metal. The method also comprises selectively jetting a binding agent onto the build material; binding the build material to form a layer: the alloying component is incorporated in the 3D object in a predetermined arrangement that comprises a first and a second region. The first region comprises the alloying component and the second region is substantially free from the alloying component or comprises the alloying component at a lower concentration than the first regions. The disclosure also relates to a kit that may be used in the method and a 3D printed structure that may be formed using the method.

### BACKGROUND

Three-dimensional (3D) printing is an additive printing process used to make three-dimensional solid objects from a digital model. Some 3D printing techniques may be considered additive processes because they involve the application of successive layers of material. This is unlike customary machine processes, which often rely upon the removal of material to create the final part.

### BRIEF DESCRIPTION OF THE DRAWING

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a simplified isometric view of an example 3D printing system that may be used to perform a 3D printing method according to an example of the present disclosure;

FIGS. 2A through 2F are schematic views depicting the formation of a 3D printed metal part according to an example of the present disclosure;

FIGS. 3 to 6 are schematic drawings of examples of structures that can be printed using examples of the methods of the present disclosure;

FIG. 7 is a schematic illustration of how an alloying component can form an alloy with a metal of the build material according to an example of the method of the present disclosure;

FIG. 8 shows an SEM-BSE image of a sample produced in the Example sintered at 650° C. for 30 min;

FIG. 9 shows an SEM-BSE images of cross-sections of samples produced in the Example sintered at 650° C. and 950° C. for 30 min; and

FIG. 10 shows an SEM-BSE image of a sample of the Example sintered at 1050° C. for 30 min.

### DETAILED DESCRIPTION

The present disclosure relates to a method of three-dimensional (3D) printing a 3D printed metal object. The method comprises selectively jetting an alloying agent onto build material. The build material comprises a first metal and the alloying agent comprises an alloying component that forms an alloy with the first metal. The method also comprises selectively jetting a binding agent onto the build material; and binding the build material to form a layer, such that the alloying component is incorporated in the 3D printed metal object in a predetermined arrangement that comprises a first region and a second region. The first region comprises the alloying component and the second region is substantially free from the alloying component or comprises the alloying component at a lower concentration than the first regions.

In some examples, the first region may be adjacent to the second region.

After binding, the build material may be sintered to a temperature of at least 300 degrees C. By exposing the build material to elevated temperatures, an alloy may be formed from the alloying component and the first metal of the build material. In some examples, the alloying component may diffuse into a matrix of the first metal to form an alloy of the alloying component and the first metal. In some examples, the first metal may diffuse into a matrix of the alloying component to form an alloy of the alloying component and the first metal. In some examples, the elevated temperatures may facilitate the formation of a solid solution of the first metal and alloying component, resulting in the formation of an alloy of the alloying component and the first metal.

The alloy may have different mechanical properties from the first metal. For example, after sintering, the alloy may have a higher stiffness and/or hardness than the first metal. It may also be possible for the alloy to have a lower stiffness and/or hardness than the first metal. Accordingly, by selectively jetting the alloying agent onto the build material, an alloy can be formed at selected locations to tailor the mechanical properties at selected locations within the 3D printed object. This can allow the structure e.g. microstructure of the 3D printed object to be engineered to provide a combination of mechanical properties.

In some examples, by selectively jetting the alloying agent onto portion(s) of the build material, regions of relatively higher stiffness and/or hardness can be interspersed with regions of relatively lower stiffness and/or hardness (e.g. where the alloying agent is not applied or applied at a lower concentration). This can allow stiffer and/or harder regions to be interspersed with more ductile and/or softer regions within the 3D printed object. The stiffer regions can provide the 3D printed object with a degree of strength, while the regions of relatively higher ductility can e.g. reduce crack propagation. In some examples, this can provide the 3D printed object with a combination of mechanical properties, e.g. strength and toughness. This can enable a 3D printed object to be printed with an engineered structure e.g. microstructure. Such structures can provide a combination of mechanical properties that, in some instances, surpass the mechanical properties that would be expected from the mechanical properties of the build material alone.

In some examples, the alloying component is incorporated in the 3D printed metal object to form a structure comprising first regions interspersed by second regions, wherein the first regions comprise an alloy formed from the first metal and alloying component. In some examples, the first regions have a higher stiffness and/or hardness than the second regions.

The present disclosure also relates to a 3D printed metal structure formed from a first metal. The structure comprises first regions interspersed by second regions. The first regions have a higher stiffness (and/or hardness) than the second regions, and the first regions comprise an alloy of the first metal and an alloying component, and the second regions comprise the first metal. In some examples, the second regions are substantially free from the alloying component. In some examples, the 3D printed structure is a microstructure that forms at least part of a 3D printed object.

The present disclosure also relates to a kit for three-dimensional (3D) printing a 3D printed metal object. The kit comprises an alloying agent comprising an alloying component dispersed in a liquid carrier; a binding agent comprising a binder dispersed in a liquid carrier; and build material comprising a first metal that forms an alloy with the alloying component.

In some examples, the alloying component comprises a component selected from carbon and a second metal.

In some examples, the binder comprises a metal salt and/or a polymer binder.

In some examples, the binder comprises a salt of the first metal.

In some examples, the build material comprises a first metal that is selected from at least one of copper, iron, nickel, titanium, aluminium, cobalt and silver.

In some examples, the first metal is copper and the alloying component comprises silver.

In some examples, the first metal is iron and the alloying component comprises carbon. In some examples, the first metal is iron and the alloying component is chromium. In some examples, the first metal is iron and the alloying component is copper.

### Build Material

The build material employed in the present disclosure may comprise at least one metal (a first metal). The build material may comprise particles of build material. For example, the build material may comprise a build material powder.

In an example, the build material is a single phase metallic material composed of one element.

In another example, the build material is composed of two or more elements, which may be in the form of a single phase metallic alloy or a multiple phase metallic alloy. For some single phase metallic alloys, melting begins just above the solidus temperature (where melting is initiated) and is not complete until the liquidus temperature (temperature at which all the solid has melted) is exceeded. For other single phase metallic alloys, melting begins just above the peritectic temperature. The peritectic temperature is defined by the point where a single phase solid transforms into a two phase solid plus liquid mixture, where the solid above the peritectic temperature is of a different phase than the solid below the peritectic temperature. When the metallic build material is composed of two or more phases (e.g., a multiphase alloy made of two or more elements), melting generally begins when the eutectic or peritectic temperature is exceeded. The eutectic temperature is defined by the temperature at which a single phase liquid completely solidifies into a two phase solid. Generally, melting of the single phase metallic alloy or the multiple phase metallic alloy begins just above the solidus, eutectic, or peritectic temperature and is not complete until the liquidus temperature is exceeded. In some examples, sintering can occur below the solidus temperature, the peritectic temperature, or the eutectic temperature. In other examples, sintering occurs above the solidus temperature, the peritectic temperature, or the eutectic temperature. Sintering above the solidus temperature is known as super solidus sintering, and this technique may be useful when utilizing larger build material particles and/or to achieve high density. It is to be understood that the sintering temperature may be high enough to offer sufficient energy to allow atom mobility between adjacent particles.

Single elements or alloys may be used as the metallic build material. Some examples of the metallic build material include steels, stainless steel, bronzes, brasses, titanium (Ti) and alloys thereof, aluminum (Al) and alloys thereof, nickel (Ni) and alloys thereof, cobalt (Co) and alloys thereof, iron (Fe) and alloys thereof, gold (Au) and alloys thereof, silver (Ag) and alloys thereof, platinum (Pt) and alloys thereof, and copper (Cu) and alloys thereof. Some specific examples include AISM OMg, 2xxx series aluminum, 4xxx series aluminum, CoCr MPI, CoCr SP2, MaragingSteel MS1, Hastelloy C, Hastelloy X, NickelAlloy HX, Inconel IN625, Inconel IN718, SS GP1, SS 17-4PH, SS 316L, Ti6Al4V, and Ti-6Al-4V ELI7. While several example alloys have been described, it is to be understood that other alloy build materials may be used, such as refractory metals.

The build material may be made up of similarly sized particles or differently sized particles. In some examples, the build material has an average particle size of from about 5 to about 20 microns.

The term “size”, as used herein with regard to the metallic build material 16, refers to the diameter of a particle, for example, a substantially spherical particle (i.e., a spherical or near-spherical particle having a sphericity of >0.84), or the average diameter of a non-spherical particle (i.e., the average of multiple diameters across the particle).

In some examples, particles of a particle size of from about 5 microns to about 20 microns have good flowability and can be spread relatively easily. As an example, the average particle size of the particles of the metallic build material may range from about 1 microns to about 200 microns. As another example, the average size of the particles of the metallic build material ranges from about 10 microns to about 100 microns. As still another example, the average size of the particles of the metallic build material ranges from 15 microns to about 50 microns.

### Alloying Agent

The alloying agent may comprise an alloying component in a liquid carrier. The alloying component may be present in amounts of about 0.2 to about volume % of the alloying agent. In some examples, the alloying component may be present in amounts of about 2 to about 8 volume %, for instance, about 4 to about 5 volume % of the alloying agent. The alloying agent may be an inkjet or fluid jet ink composition.

The alloying component may comprise nanoparticles dispersed in a liquid carrier. The nanoparticles may comprise at least one metal (second metal) or carbon. In other examples, the alloying component may be dissolved in a liquid carrier. For instance, the alloying component may comprise a metal salt dissolved in a liquid carrier. The metal salt may be a salt of the second metal. The second metal may form an alloy with the first metal of the build material.

The alloying agent may be applied to the build material, such that the alloying component is incorporated in the 3D printed metal object in a predetermined arrangement that comprises a first region and a second region. The first region comprises the alloying component and the second region is substantially free from the alloying component or comprises the alloying component at a lower concentration than the first regions.

The alloying component may be incorporated in the first region(s) at a concentration of about 0.05 atomic % to about 30 atomic %, for instance, 0.1 to about 27 atomic % or 0.2 to about 25 atomic %. In some examples, the alloying component may be incorporated in the first region(s) at a concentration of about 0.3 atomic % to about 20 atomic %, for example, 0.4 atomic % to about 15 atomic %.

The alloying component may be employed to form an alloy with the build material in the first region(s) of the 3D printed object. These alloyed regions may have mechanical properties that are different from the mechanical properties of regions formed from build material that e.g. has not been treated by or treated with less of the alloying component. For example, the alloyed regions may have a higher hardness, stiffness and/or strength (e.g. flexural and/or tensile strength) than regions formed from build material that has not been treated by or treated with less of the alloying component. In other examples, the alloyed regions may have a different (e.g. higher or lower) strength, ductility, toughness, corrosion resistance, wear resistance, fatigue and/or creep than regions formed from build material that has not been treated by or treated with less of the alloying component.

By selectively applying the alloying component to first region(s) of the build material, it is possible to form a structure in which the first regions are interspersed with the second regions in which the alloying component is absent. In this way, a structure of alternating first and second regions may be formed. Where the first regions are stiffer and/or harder than the second regions, the resulting structure may have stiff and/or harder regions interspersed by more ductile and/or softer regions. The stiffer and/or harder regions may impart a degree of strength to the resulting structure, while the more ductile and/or softer regions may help to slow or guide crack propagation. These alternating or interspersed stiffer/harder and more ductile/softer regions may provide the resulting structure with a desirable blend of mechanical properties. In some examples, the more ductile and/or softer regions may be used to provide a fracture path through the part e.g. to avoid or the risk of the part failing at undesirable points, to avoid or reduce the risk of the part failing in an undesirable pattern and/or to provide a more failsafe design.

The alloying component may be selected depending on the nature of the build material. Examples of suitable materials for the alloying component include carbon, magnesium, manganese, aluminum, iron, titanium, niobium, tungsten, chromium, tantalum, cobalt, nickel, vanadium, zirconium, molybdenum, palladium, platinum, copper, silver, gold, cadmium, zinc, arsenic, beryllium, tin, silicon, tellurium, lead, phosphorus and combinations of these with each other and/or with a non-metallic element or elements.

Where the alloying component comprises carbon nanoparticles, the build material may comprise iron. In some examples where the alloying component comprises carbon nanoparticles, the build material may comprise steel. The alloying component may be selectively applied to the build material to increase the carbon content of the steel. For example, where the build material comprises a low carbon steel, an alloying component comprising carbon nanoparticles may be employed to form a steel having a higher carbon content than the starting build material.

In some examples, the build material may be a low carbon steel having a carbon content of about 0.30 weight % or lower, for instance, about 0.05 to about 0.3 weight %. An alloying agent comprising carbon nanoparticles may be selectively applied to form a first region in the 3D printed object, where the carbon content of the steel alloy in the first region is increased to about 0.3 weight % or more. For example, the carbon content of the steel alloy in the first region may be at least about 0.4 weight %, at least about 0.6 weight %, at least about 1.0 weight % or at least about 1.25 weight %. The alloying agent may be selectively applied to form a medium carbon, high carbon or ultra-high carbon steel in the first region(s). In some examples, the first region(s) may have a carbon content of about 0.3 to about 0.6 weight % (medium-carbon steel), about 0.6 to about 1.0 weight % (high-carbon steel) or about 1.25 weight % to about 2.0 weight % (ultra-high carbon steel). The carbon content of the steel may be increased in certain (first) regions to provide stiffer or stronger regions in the structure of the part.

In other examples, the build material may be a medium or high carbon steel, and the alloying agent may be applied to increase the carbon content of the build material at selected (first) regions. By increasing the carbon content, higher carbon steels can be produced at the first regions.

The alloying component may also comprise a metal that may alloy with iron in the build material to form a different steel alloy. Examples of suitable metals include chromium, cobalt, molybdenum, nickel, niobium, titanium, tungsten, vanadium, copper and/or zirconium. Multiple alloying agents may be employed to provide the desired alloy composition. Alternatively or additionally, an alloying agent comprising more than one alloying component may be employed.

In some examples, the build material may comprise iron. An alloying component may be used to form a steel alloy in selected regions.

In some examples, the build material may comprise a first steel alloy. An alloying component may be used to form a second steel alloy in selected regions. The first alloy is different from the second alloy.

In some examples, the build material may comprise a first stainless steel alloy. An alloying component may be used to form a second stainless steel alloy in selected regions. The first alloy is different from the second alloy.

In some examples, the build material may comprise copper. The alloying agent may comprise an alloying component that forms an alloy with the metal (e.g. copper) in the build material. Examples of metals that form alloys with copper include Ag, Al, As, Be, Cd, Co, Fe, Mn, Mg, Ni, Sn, Si, Te, Pb, P and Zn. Combinations of two or more of these metals may be present in the alloying agent. Alternatively, separate alloying agents may be employed to provide the desired alloy. In one example where the build material comprises copper, the alloying agent comprises silver (e.g. silver nanoparticles) as the alloying component.

In some examples, the build material may comprise Ti, Co and/or Ni. Accordingly, the alloying agent may comprise alloying components that form Ti alloys, Co alloys and/or Ni alloys. Examples of such alloying components include Al, V, Cr, Fe, Cu and combinations thereof. For example, where the build material comprises Ti, the alloying component may comprise Al and/or V. Where the build material comprises Co, the alloying component may comprise Cr. Where the build material comprises Ni, the build material may comprise Cr, Fe and/or Cu. Combinations of two or more of these metals may be present in the alloying agent. Alternatively, separate alloying agents may be employed to provide the desired alloy.

The alloying agent may include nanoparticles with dimensions that are in the nanometer size range, that is, from about 1 nanometer to about 1,000 nanometers. In an example, the nanoparticles may be in a size range of about 1 nanometers to about 100 nanometers, and for example within a range of about 1 to about 50 nanometers. The nanoparticles may have any shape.

Suitable nanoparticles for the alloying agent include nanoparticles formed from: carbon, magnesium, manganese, aluminum, iron, titanium, niobium, tungsten, chromium, tantalum, cobalt, nickel, vanadium, zirconium, molybdenum, palladium, platinum, copper, silver, gold, cadmium, zinc, arsenic, beryllium, tin, silicon, tellurium, lead, phosphorus and combinations of these with each other and/or with a non-metallic element or elements.

Where the alloying component comprises a metal salt, suitable metal salts include salts of copper, silver, iron, nickel, manganese, chromium or cobalt. In some examples, the metal salt may be a salt of copper. Examples of salts include nitrates, sulfates, formates, and acetates. Suitable salts may be selected from the group consisting of copper nitrate, iron nitrate, nickel nitrate, manganese nitrate, cobalt nitrate, iron acetate, and combinations thereof. In one example, the metal salt is copper nitrate. The metal salt may be hydrated.

The alloying agent may be a liquid composition comprising a liquid carrier. The alloying agent may be a jettable composition, i.e. an inkjet or fluidjet ink composition. Suitable liquid carriers include water or a non-aqueous solvent (e.g. ethanol, acetone, n-methyl pyrrolidone, aliphatic hydrocarbons or combinations thereof).

In some examples, the alloying agent may further comprise at least one of: a co-solvent, a surfactant, a dispersant, a biocide, an anti-kogation agent, viscosity modifiers, buffers, stabilizers, and combinations thereof. The presence of a co-solvent, a surfactant, and/or a dispersant in the agent may assist in obtaining a particular wetting behaviour when the alloying agent is applied to the build material.

Examples of co-solvents that may be used include aliphatic alcohols, aromatic alcohols, diols, glycol ethers, polyglycol ethers, 2-pyrrolidones, caprolactams, formamides, acetamides, glycols, and long chain alcohols. Examples of these co-solvents include primary aliphatic alcohols, secondary aliphatic alcohols, 1,2-alcohols, 1,3-alcohols, 1,5-alcohols, ethylene glycol alkyl ethers, propylene glycol alkyl ethers, higher homologs (C6-C12) of polyethylene glycol alkyl ethers, N-alkyl caprolactams, unsubstituted caprolactams, both substituted and unsubstituted formamides, both substituted and unsubstituted acetamides, and the like. Other examples of some suitable co-solvents include water-soluble high-boiling point solvents (i.e., humectants), which have a boiling point of at least about 120° C., or higher. Some examples of high-boiling point solvents include 2-pyrrolidone (boiling point of about 245° C.), 2-methyl-1,3-propanediol (boiling point of about 212° C.), and combinations thereof.

The co-solvent(s) may be present in the alloying agent in a total amount ranging from about 1 wt % to about 70 wt % based upon the total weight of the alloying agent, depending upon the jetting architecture of the applicator.

Surfactant(s) may be used to improve the wetting properties and the jettability of the alloying agent. In some examples, the surfactant can be DowfaxT™ 2A1. Examples of suitable surfactants include a self-emulsifiable, nonionic wetting agent based on acetylenic diol chemistry (e.g., SURFYNOL® SEF from Air Products and Chemicals, Inc.), a nonionic fluorosurfactant (e.g., CAPSTONE® fluorosurfactants from DuPont, previously known as ZONYL FSO), and combinations thereof. In other examples, the surfactant is an ethoxylated low-foam wetting agent (e.g., SURFYNOL®440 or SURFYNOL® CT-1 1 1 from Air Products and Chemical Inc.) or an ethoxylated wetting agent and molecular defoamer (e.g., SURFYNOL®420 from Air Products and Chemical Inc.). Still other suitable surfactants include non-ionic wetting agents and molecular defoamers (e.g., SURFYNOL® 104E from Air Products and Chemical Inc.) or water-soluble, non-ionic surfactants (e.g., TERGITOL™ TMN-6 or TERGITOL™ 15-S-7 from The Dow Chemical Company). In some examples, it may be useful to utilize a surfactant having a hydrophilic-lipophilic balance (HLB) less than 10.

Whether a single surfactant is used or a combination of surfactants is used, the total amount of surfactant(s) in the alloying agent may range from about 0.01 wt % to about 10 wt % based on the total weight of the alloying agent. In another example, the total amount of surfactant(s) in the alloying agent may range from about 0.5 wt % to about 2.5 wt % based on the weight of the alloying agent.

The alloying agent may also include antimicrobial agent(s). Suitable antimicrobial agents include biocides and fungicides. Example antimicrobial agents may include the NUOSEPT™ (Troy Corp.), UCARCIDE™ (Dow Chemical Co.), ACTICIDE® M20 (Thor), and combinations thereof.

Examples of suitable biocides include an aqueous solution of 1,2-benzisothiazolin-3-one (e.g., PROXEL® GXL from Arch Chemicals, Inc.), quaternary ammonium compounds (e.g., Bardac® 2250 and 2280, Barquat®50-65B, and Carboquat® 250-T, all from Lonza Ltd. Corp.), and an aqueous solution of methylisothiazolone (e.g., Kordek® MLX from Dow Chemical Co.). The biocide or antimicrobial may be added in any amount ranging from about 0.05 wt % to about 0.5 wt % (as indicated by regulatory usage levels) with respect to the total weight of the alloying agent.

An anti-kogation agent may be included in the alloying agent. Kogation refers to the deposit of dried ink (e.g. binding agent) on a heating element of a thermal inkjet printhead. Anti-kogation agent(s) is/are included to assist in preventing the buildup of kogation. Examples of suitable anti-kogation agents include oleth-3-phosphate (e.g., commercially available as CRODAFOS™ 03A or CRODAFOS™ N-3 acid from Croda), or a combination of oleth-3-phosphate and a low molecular weight (e.g., <5,000) polyacrylic acid polymer (e.g., commercially available as CARBOSPERSE™ K-7028 Polyacrylate from Lubrizol).

Whether a single anti-kogation agent is used or a combination of anti-kogation agents is used, the total amount of anti-kogation agent(s) in the alloying agent may range from greater than 0.20 wt % to about 0.62 wt % based on the total weight of the alloying agent. In an example, the oleth-3-phosphate is included in an amount ranging from about 0.20 wt % to about 0.60 wt %, and the low molecular weight polyacrylic acid polymer is included in an amount ranging from about 0.005 wt % to about 0.03 wt %.

Sequestering agents, such as EDTA (ethylene diamine tetra acetic acid), may be included to eliminate the deleterious effects of heavy metal impurities, and buffer solutions may be used to control the pH of the binding agent. From 0.01 wt % to 2 wt % of each of these components, for example, can be used. Viscosity modifiers and buffers may also be present, as well as other known additives to modify properties of the binding agent. Such additives can be present in amounts ranging from about 0.01 wt % to about 20 wt %.

### Binding Agent

Any suitable binding agent may be used. In some examples, the binding agent may be a liquid composition comprising a binder in a liquid carrier. The binder may include a metal (e.g. the second metal in a kit according to the present disclosure). For example, the binder may be a metal salt (e.g. hydrated metal salt) dispersed or dissolved in a liquid carrier. Other examples of binders include polymer binders. Where the binder comprises a metal, the metal may be the same as the metal of the build material.

In some examples, a metal salt may be employed as the binder. The metal salt may be a hydrated metal salt. The metal of the metal salt may be the same or different from the metal of the build material. The metal of the metal salt may be the same as the metal of the build material. In some examples, the metal of the metal salt may be the same as the metal of the build material at least in the region where the detectable marker is located.

The metal salt may be a salt of copper, silver iron, nickel, manganese, chromium or cobalt. In some examples, the metal salt may be a salt of copper. Examples of salts include nitrates, sulfates, formates, and acetates.

Where a hydrated metal salt is employed, the hydrated metal salt can be selected from the group consisting of hydrated copper nitrate, hydrated iron nitrate, hydrated nickel nitrate, hydrated manganese nitrate, hydrated cobalt nitrate, hydrated iron acetate, and combinations thereof.

In one example, the hydrated metal salt is copper nitrate.

In some examples, the at least one hydrated metal salt is present in the binding agent in an amount of from about 5 wt % to about 50 wt % based on the total weight of the binding agent, or from about 10 wt % to about 50 wt % based on the total weight of the binding agent, or from about 15 wt % to about 50 wt % based on the total weight of the binding agent, or from about 20 wt % to about 50 wt % based on the total weight of the binding agent, or from about 25 wt % to about 50 wt % based on the total weight of the binding agent, or from about 30 wt % to about 50 wt % based on the total weight of the binding agent, or from about 35 wt % to about 50 wt % based on the total weight of the binding agent, or from about 40 wt % to about 50 wt % based on the total weight of the binding agent, or from about 45 wt % to about 50 wt % based on the total weight of the binding agent, or less than about 50 wt % based on the total weight of the binding agent, or less than about 45 wt % based on the total weight of the binding agent, or less than about 40 wt % based on the total weight of the binding agent, or less than about 35 wt % based on the total weight of the binding agent, or less than about 30 wt % based on the total weight of the binding agent, or less than about 25 wt % based on the total weight of the binding agent, or less than about 20 wt % based on the total weight of the binding agent, or less than about 15 wt % based on the total weight of the binding agent, or less than about 10 wt % based on the total weight of the binding agent.

Other examples of binders include polymer binders and binders comprising sugars polycarboxylic acids, polysulfonic acids, and polyether alkoxy silanes.

Where a polymer binder is employed, the polymer binder may be a semi-crystalline polymer, such as polypropylene and polyethylene. The polymer binder may be a non-crystalline polymer, such as polyethylene oxide, polyethylene glycol (solid), acrylonitrile butadiene styrene, polystyrene, styrene-acrylonitrile resin, and polyphenyl ether. The polymer binder may be selected from the group consisting of polypropylene, polyethylene, low density polyethylene, high density polyethylene, polyethylene oxide, polyethylene glycol, acrylonitrile butadiene styrene, polystyrene, styrene-acrylonitrile resin, polyphenyl ether, polyacrylate, polymethylmethacrylate, polyamide 1 1, polyamide 12, polymethyl pentene, polyoxymethylene, polyethylene terephthalate, polybutylene terephthalate, polyvinylidene fluoride, polytetrafluoroethylene, perfluoroalkoxy alkane, polyphenylene sulfide, and polyether ether ketone.

The polymer binder may have a melting point temperature less than about 250° C., for example it may range from about 50° C. to about 249° C., for example from about 60° C. to about 240° C., and as a further example from about 70° C. to about 235° C.

The polymer binder may be present in the binding agent in an amount ranging from about 1% to about 20% by volume, for example from about 2% to about 16% by volume, and as a further example from about 3% to about 5% by volume or 12 to 16% by volume. In another aspect, the polymer binder may be present in the binding agent in an amount up to 100% by volume loading, for example, if using a piezo ink jet to jet the polymer precursor materials.

In some examples, the binder comprises sugars, sugar alcohols, polymeric or oligomeric sugars, low or moderate molecular weight polycarboxylic acids, polysulfonic acids, water soluble polymers containing carboxylic or sulfonic moieties, and polyether alkoxy silane. Some specific examples include glucose (C₆Hi₂O₆), sucrose (C₁₂H₂₂O₁₁), fructose (C₆H₁₂O₆), maltodextrines with a chain length ranging from 2 units to 20 units, sorbitol (C₆H₁₄O₆), erythritol (C₄H₁₀O₄), mannitol (C₆H₁₄O₆), or CARBOSPERSE® K7028 (a short chain polyacrylic acid, M-2,300 Da, available from Lubrizol). Low or moderate molecular weight polycarboxylic acids (e.g., having a molecular weight less than 5,000 Da) may dissolve relatively fast. It is to be understood that higher molecular weight polycarboxylic acids (e.g., having a molecular weight greater than 5,000 Da up to 10,000 Da) may be used; however the dissolution kinetics may be slower.

As mentioned above, the binding agent can include the binder and the liquid carrier. As used herein, “liquid carrier” may refer to the liquid in which the binder is dispersed to form the binding agent. A wide variety of liquid carriers, including aqueous and non-aqueous vehicles, may be used in the binding agent. In some instances, the liquid carrier consists of a primary solvent with no other components. In other examples, the binding agent may include other ingredients, depending, in part, upon the applicator that is to be used to dispense the binding agent.

Examples of suitable optional binding agent components include co-solvents), surfactant(s), antimicrobial agent(s), anti-kogation agent(s), viscosity modifier(s), pH adjuster(s) and/or sequestering agent(s). The presence of a co-solvent and/or a surfactant in the binding agent may assist in obtaining a particular wetting behavior with the metallic build material.

The primary solvent may be water or a non-aqueous solvent (e.g., ethanol, acetone, n-methyl pyrrolidone, aliphatic hydrocarbons, or combinations thereof). In some examples, the binding agent consists of the hydrated metal salt and the primary solvent (with no other components). In these examples, the primary solvent makes up the balance of the binding agent.

Classes of organic co-solvents that may be used in the water-based binding agent include aliphatic alcohols, aromatic alcohols, diols, glycol ethers, polyglycol ethers, 2-pyrrolidones, caprolactams, formamides, acetamides, glycols, and long chain alcohols. Examples of these co-solvents include primary aliphatic alcohols, secondary aliphatic alcohols, 1,2-alcohols, 1,3-alcohols, 1,5-alcohols, ethylene glycol alkyl ethers, propylene glycol alkyl ethers, higher homologs (C6-C12) of polyethylene glycol alkyl ethers, N-alkyl caprolactams, unsubstituted caprolactams, both substituted and unsubstituted formamides, both substituted and unsubstituted acetamides, and the like.

Examples of some suitable co-solvents include water-soluble high-boiling point solvents (i.e., humectants), which have a boiling point of at least 120° C., or higher. Some examples of high-boiling point solvents include 2-pyrrolidone (boiling point of about 245° C.), 2-methyl-1,3-propanediol (boiling point of about 212° C.), and combinations thereof. The co-solvent(s) may be present in the binding agent in a total amount ranging from about 1 wt % to about 70 wt % based upon the weight of the binding agent, depending upon the jetting architecture of the applicator.

In some examples, the binding agent can include a coalescing solvent. For example, where the binder is a polymer binder, the binding agent can include a coalescing solvent.

In some examples, the coalescing solvent may be a lactone, such as 2-pyrrolidinone or 1-(2-hydroxyethyl)-2-pyrrolidone. In other examples, the coalescing solvent may be a glycol ether or a glycol ether esters, such as tripropylene glycol mono methyl ether, dipropylene glycol mono methyl ether, dipropylene glycol mono propyl ether, tripropylene glycol mono n-butyl ether, propylene glycol phenyl ether, dipropylene glycol methyl ether acetate, diethylene glycol mono butyl ether, diethylene glycol mono hexyl ether, ethylene glycol phenyl ether, diethylene glycol mono n-butyl ether acetate, ethylene glycol mono n-butyl ether acetate, or combinations thereof. In still other examples, the coalescing solvent may be a water-soluble polyhydric alcohol, such as 2-methyl-1,3-propanediol. In still other examples, the coalescing solvent may be a combination of any of the examples above. In still other examples, the coalescing solvent is selected from the group consisting of 2-pyrrolidinone, 1-(2-hydroxyethyl)-2-pyrrolidone, tri-propylene glycol mono methyl ether, dipropylene glycol mono methyl ether, dipropylene glycol mono propyl ether, tri-propylene glycol mono n-butyl ether, propylene glycol phenyl ether, dipropylene glycol methyl ether acetate, diethylene glycol mono butyl ether, diethylene glycol mono hexyl ether, ethylene glycol phenyl ether, diethylene glycol mono n-butyl ether acetate, ethylene glycol mono n-butyl ether acetate, 2-methyl-1,3-propanediol, and a combination thereof.

The coalescing solvent may be present in the binding agent in an amount ranging from about 0.1 wt % to about 70 wt % (based upon the weight of the binding agent). In some examples, greater or lesser amounts of the coalescing solvent may be used depending, in part, upon the jetting architecture of the applicator.

Surfactant(s) may be used to improve the wetting properties and the jettability of the binding agent. In some examples, the surfactant can be Dowfax™ 2A1. Examples of suitable surfactants include a self-emulsifiable, nonionic wetting agent based on acetylenic diol chemistry (e.g., SURFYNOL® SEF from Air Products and Chemicals, Inc.), a nonionic fluorosurfactant (e.g., CAPSTONE® fluorosurfactants from DuPont, previously known as ZONYL FSO), and combinations thereof. In other examples, the surfactant is an ethoxylated low-foam wetting agent (e.g., SURFYNOL® 440 or SURFYNOL® CT-1 1 1 from Air Products and Chemical Inc.) or an ethoxylated wetting agent and molecular defoamer (e.g., SURFYNOL®®420 from Air Products and Chemical Inc.). Still other suitable surfactants include non-ionic wetting agents and molecular defoamers (e.g., SURFYNOL®104E from Air Products and Chemical Inc.) or water-soluble, non-ionic surfactants (e.g., TERGITOL™ TMN-6 or TERGITOL™ 15-S-7 from The Dow Chemical Company). In some examples, it may be useful to utilize a surfactant having a hydrophilic-lipophilic balance (HLB) less than 10.

Whether a single surfactant is used or a combination of surfactants is used, the total amount of surfactant(s) in the binding agent may range from about 0.01 wt % to about 10 wt % based on the total weight of the binding agent. In another example, the total amount of surfactant(s) in the binding agent may range from about 0.5 wt % to about 2.5 wt % based on the weight of the binding agent.

The liquid vehicle may also include antimicrobial agent(s). Suitable antimicrobial agents include biocides and fungicides. Example antimicrobial agents may include the NUOSEPT™ (Troy Corp.), UCARCIDE™ (Dow Chemical Co.), ACTICIDE® M20 (Thor), and combinations thereof.

Examples of suitable biocides include an aqueous solution of 1,2-benzisothiazolin-3-one (e.g., PROXEL® GXL from Arch Chemicals, Inc.), quaternary ammonium compounds (e.g., Bardac®2250 and 2280. Barquat® 50-65B, and Carboquat® 250-T, all from Lonza Ltd. Corp.), and an aqueous solution of methylisothiazolone (e.g., Kordek® MLX from Dow Chemical Co.). The biocide or antimicrobial may be added in any amount ranging from about 0.05 wt % to about 0.5 wt % (as indicated by regulatory usage levels) with respect to the weight of the binding agent.

An anti-kogation agent may be included in the binding agent. Kogation refers to the deposit of dried ink (e.g. binding agent) on a heating element of a thermal inkjet printhead. Anti-kogation agent(s) is/are included to assist in preventing the buildup of kogation. Examples of suitable anti-kogation agents include oleth-3-phosphate (e.g., commercially available as CRODAFOS™ 03A or CRODAFOS™ N-3 acid from Croda), or a combination of oleth-3-phosphate and a low molecular weight (e.g., <5,000) polyacrylic acid polymer (e.g., commercially available as CARBOSPERSE™ K-7028 Polyacrylate from Lubrizol). Whether a single anti-kogation agent is used or a combination of anti-kogation agents is used, the total amount of anti-kogation agent(s) in the binding agent may range from greater than 0.20 wt % to about 0.62 wt % based on the weight of the binding agent 36. In an example, the oleth-3-phosphate is included in an amount ranging from about 0.20 wt % to about 0.60 wt %, and the low molecular weight polyacrylic acid polymer is included in an amount ranging from about 0.005 wt % to about 0.03 wt %.

Sequestering agents, such as EDTA (ethylene diamine tetra acetic acid), may be included to eliminate the deleterious effects of heavy metal impurities, and buffer solutions may be used to control the pH of the binding agent. From 0.01 wt % to 2 wt % of each of these components, for example, can be used. Viscosity modifiers and buffers may also be present, as well as other known additives to modify properties of the binding agent. Such additives can be present in amounts ranging from about 0.01 wt % to about 20 wt %.

For the avoidance of doubt, the binding agent may be jetted onto portions of the build material where the alloying agent is absent. For example, the binding agent may be jetted onto the build material to delineate or surround the region(s) where alloying agent is applied. Alternatively, the binding agent may also be jetted onto at least portions of the build material where the alloying agent is present. Thus, the first region(s) of the predetermined arrangement may be formed by the alloying agent as well as the binding agent.

### 3D Printing

As described above, the present disclosure relates to a method of three-dimensional (3D) printing a metal part. The method comprises selectively jetting a binding agent onto at least a portion of the build material, and binding the build material to form a layer.

In 3D printing, a layer of build material may be applied to a print platform. A binding agent may then be selectively jetted onto at least a portion of the layer of build material. A further layer of build material may then be applied, and a binding agent may then be selectively jetted onto a portion of the newly applied layer. The process may be repeated one or more times.

By selectively jetting the binding agent onto the build material, the build material becomes patterned. The patterned build material may then be bound to form a layer. Binding may be carried out e.g. by applying heat to the patterned build material. For example, heating may cause at least some of the liquid in the binding agent to evaporate. This evaporation may result in some densification, for example, through capillary action of the layer. Alternatively or additionally, heating may cause physical and/or chemical changes in the binder that cause the build material to be stabilised.

Binding may be performed after a single pass of the binding agent or after a few passes of binding agent have been applied. Alternatively or additionally, binding may be performed to a patterned 3D printed object to affect the binding of multiple layers.

In the present disclosure, an alloying agent is also selectively jetted onto the build material. The alloying agent may be selectively jetted at predetermined locations on predetermined layers of the build material. Accordingly, the alloying agent can be incorporated into the metal part in a predetermined arrangement. The predetermined arrangement comprises a first region comprising the alloying component and a second region that is substantially free from the alloying component or comprises the alloying component at a lower concentration than the first regions. On exposure to elevated temperatures, for example, during sintering, the alloying component may form an alloy with the metal in the build material. The alloy may have a relatively high stiffness, hardness and/or strength. Thus, the first region(s) comprising the alloy may have a higher stiffness, hardness and/or strength than the second region(s), which are substantially free from the alloying component or comprises the alloying component at a lower concentration than the first regions.

In some examples, a binding agent and an alloying agent may be applied to a layer of build material. The binding agent and alloying agent may be applied in distinct locations on the build material. In these examples, the alloying agent may also have a binding function e.g. under the printing conditions, so, as well as being useful for forming alloy in the first region(s), the alloying agent may also bind the build material in the region where alloying agent is applied. In some examples, the binding agent may be applied at a location adjacent to the location where the alloying agent is applied. In some examples, the binding agent may be applied to delineate a region where alloying agent is applied.

In some examples, some binding agent may be also be applied to the region where alloying agent is applied. For instance, where the alloying agent cannot provide a binding function e.g. under the printing conditions (e.g. temperature too low), the binding function may be provided by the binding agent. Alternatively or additionally, the binding agent may supplement any binding properties of the alloying agent. In these examples, the first region(s) of the predetermined arrangement may be formed of the alloying agent and the binding agent.

The procedure used to bind the build material may depend, for example, the nature of the build material, the binding agent and/or the alloying agent. In some examples, binding may be performed by heating to a binding temperature of, for instance, about 80 to about 300 degrees C.

In some examples, the binding temperature may be from about 100° C. to about 280° C., or from about 100° C. to about 250° C., or from about 100° C. to about 240° C., or from about 100° C. to about 230°. In some examples, the binding temperature may be from about 130° C. to about 280° C., or from about 140° C. to about 250° C., or from about 150° C. to about 240° C., or from about 160° C. to about 230°.

In some examples, after binding, the build material (e.g. patterned with the binding agent and/or alloying agent) may be sintered. Suitable sintering temperatures are from about 300° C. to about 1800° C., or from about 350° C. to about 1500° C., or from about 400° C. to about 1500° C., or from about 450° C. to about 1500° C., or from about 500° C. to about 1500° C., or from about 550° C. to about 1500° C., or from about 600° C. to about 1500° C., or from about 650° C. to about 1500° C., or from about 700° C. to about 1500° C., or from about 800° C. to about 1500° C., or from about 900 to about 1500° C., or from about 1000° C. to about 1500° C., or from about 1100° C. to about 1500° C., or from about 1200° C. to about 1500° C., or from about 1300° C. to about 1500° C., or from about 1400° C. to about 1500° C.

In some examples, sintering may be performed at about 300 to about 1100° C., for instance, from about 450° C. to about 900° C.

In some examples, the heating of the three-dimensional object to the sintering temperature is performed for a sintering time period ranging from about 10 minutes to about 20 hours, or at least 10 minutes, or at least 1 hour, or at least 8 hours, or at least 10 hours, or at least 15 hours, or at least 20 hours.

Sintering may be performed in a reducing atmosphere, for example, in the presence of hydrogen. In some examples, sintering may be performed in the presence of hydrogen and/or an inert gas, for example, argon or under vacuum. In some examples, sintering may be performed in at inert atmosphere.

Sintering cycles may be tailored to the specific alloys being formed during the 3D printing process.

When the binder is heated, for example, during sintering, at least partial decomposition of the binder can occur. This decomposition may facilitate consolidation of the build material to form the 3D printed object. For example, where a polymer binder is employed, heating e.g. during sintering may cause polymer burn-out, such that the polymer binder is removed from the sintered product. Where a hydrated metal salt is employed as the binder, the hydrated metal salt can be dehydrated, then decomposed to a metal oxide and subsequently reduced to a metal. This stage-wise decomposition may occur on exposure to elevated temperatures, for example, during binding and/or sintering.

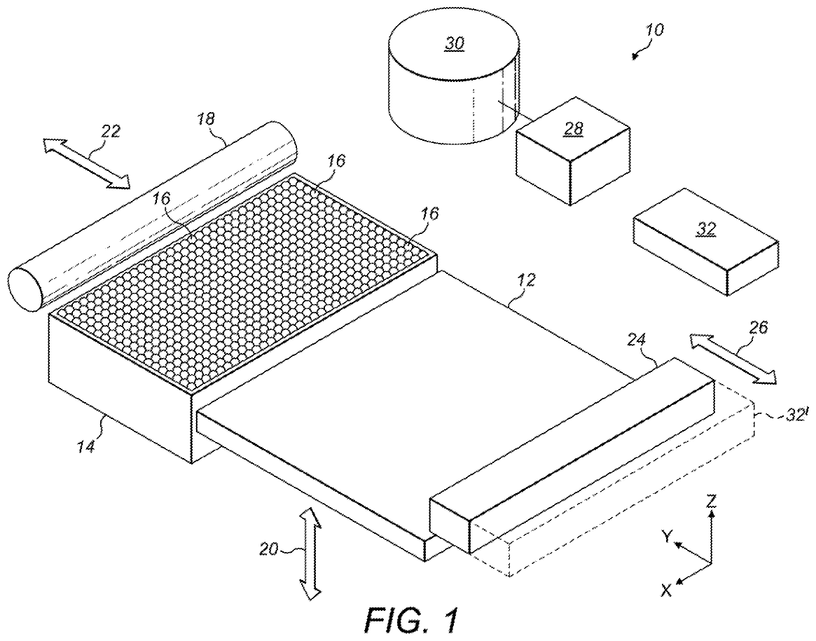

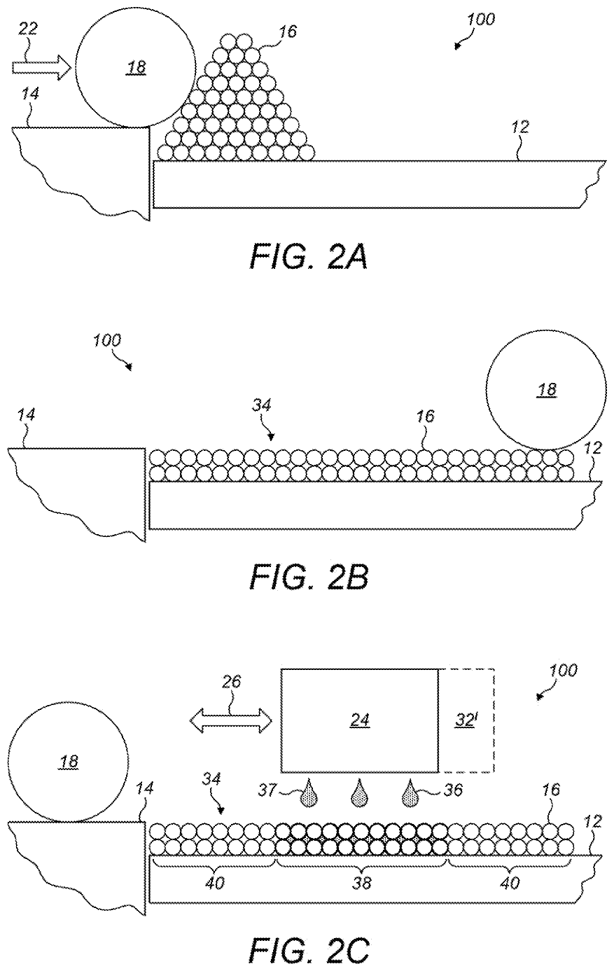

### FIGS. 1 to 2F

As used herein, the term “patterned 3D printed object” refers to an intermediate part that has a shape representative of the final 3D printed part and that includes build material patterned with a binding agent and/or alloying agent. In the patterned 3D printed object, the build material particles may or may not be weakly bound together by at least one component of the binding agent and/or alloying agent, and/or by attractive force(s) between build material particles and the binding agent and/or alloying agent. It is to be understood that any build material that is not patterned with the binding agent and/or alloying agent is not considered to be part of the patterned 3D printed object, even if it is adjacent to or surrounds the patterned 3D printed object.

Referring now to FIG. 1, an example of a 3D printing system 10 is depicted. It is to be understood that the 3D printing system 10 may include additional components and that some of the components described herein may be removed and/or modified. Furthermore, components of the 3D printing system 10 depicted in FIG. 1 may not be drawn to scale and thus, the 3D printing system 10 may have a different size and/or configuration other than as shown therein.

The three-dimensional (3D) printing system 10 may include a supply 14 of e.g. metallic build material 16; a build material distributor 18; a supply of a binding agent and a supply of a alloying agent; an inkjet applicator 24 for selectively dispensing the binding agent or alloying agent 36, 37 (see FIG. 2C); at least one heat source 32; a controller 28; and a non-transitory computer readable medium having stored thereon computer executable instructions to cause the controller 28 to: utilize the build material distributor 18 to iteratively form multiple layers 34 (FIG. 2B) of metallic build material 16, and the inkjet applicator 24 to selectively apply binding agent 36 and alloying agent 37, thereby creating a patterned 3D printed object 42 (FIG. 2E), and utilize the at least one heat source 32 to heat 46 the patterned 3D printed object 42 to about a temperature to affect binding of the metallic build material particles 16 by creating a 3D printed object 42, and heat the 3D printed object 42 to a sintering temperature to form a sintered 3D printed object.

As shown in FIG. 1, the printing system 10 includes a build area platform 12, the build material supply 14 containing metallic build material particles 16, and the build material distributor 18.

The build area platform 12 receives the metallic build material 16 from the build material supply 14. The build area platform 12 may be integrated with the printing system 10 or may be a component that is separately insertable into the printing system 10. For example, the build area platform 12 may be a module that is available separately from the printing system 10. The build area platform 12 that is shown is also one example, and could be replaced with another support member, such as a platen, a fabrication/print bed, a glass plate, or another build surface.

The build area platform 12 may be moved in a direction as denoted by the arrow 20, e.g., along the z-axis, so that metallic build material 16 may be delivered to the platform 12 or to a previously formed layer of metallic build material 16 (see FIG. 2D). In an example, when the metallic build material particles 16 are to be delivered, the build area platform 12 may be programmed to advance (e.g., downward) enough so that the build material distributor 18 can push the metallic build material particles 16 onto the platform 12 to form a layer 34 of the metallic build material 16 thereon (see, e.g., FIGS. 2A and 2B). The build area platform 12 may also be returned to its original position, for example, when a new part is to be built.

The build material supply 14 may be a container, bed, or other surface that is to position the metallic build material particles 16 between the build material distributor 18 and the build area platform 12. In some examples, the build material supply 14 may include a surface upon which the metallic build material particles 16 may be supplied, for instance, from a build material source (not shown) located above the build material supply 14. Examples of the build material source may include a hopper, an auger conveyer, or the like.

Additionally, or alternatively, the build material supply 14 may include a mechanism (e.g., a delivery piston) to move the metallic build material particles 16 from a storage location to a position to be spread onto the build area platform 12 or onto a previously formed layer of metallic build material 16.

The build material distributor 18 may be moved in a direction as denoted by the arrow 22, e.g., along the y-axis, over the build material supply 14 and across the build area platform 12 to spread a layer of the metallic build material 16 over the build area platform 12. The build material distributor 18 may also be returned to a position adjacent to the build material supply 14 following the spreading of the metallic build material 16. The build material distributor 18 may be a blade (e.g., a doctor blade), a roller, a combination of a roller and a blade, and/or any other device capable of spreading the metallic build material particles 16 over the build area platform 12. For instance, the build material distributor 18 may be a counter-rotating roller.

The metallic build material 16 may be any particulate metallic material. In an example, the metallic build material 16 may be a powder. In another example, the metallic build material 16 may have the ability to sinter into a continuous body to form the metallic part 50 (see, e.g., FIG. 2F) when heated 52 to the sintering temperature (e.g., a temperature ranging from about 850° C. to about 1400° C.). In some examples, discrete metallic build material 16 powder particles should no longer be visible in the metallic part 50 (FIG. 2F). After sintering the powder particles form a dense solid metallic part.

While an example sintering temperature range is described, it is to be understood that this temperature may vary, depending, in part, upon the composition and phase(s) of the metallic build material 16.

The applicator 24 may be scanned across the build area platform 12 in the direction indicated by the arrow 26, e.g., along the y-axis. The applicator 24 may be, for instance, an inkjet applicator, such as a thermal inkjet printhead, a piezoelectric printhead, or a continuous inkjet printhead, and may extend a width of the build area platform 12. While the applicator 24 is shown in FIG. 1 as a single applicator, it is to be understood that the applicator 24 may include multiple applicators that span the width of the build area platform 12. Additionally, the applicators 24 may be positioned in multiple print bars. The applicator 24 may also be scanned along the x-axis, for instance, in configurations in which the applicator 24 does not span the width of the build area platform 12 to enable the applicator 24 to deposit the binding agent 36 or alloying agent 37 at selected locations over a large area of a layer of the metallic build material 16. The applicator 24 may thus be attached to a moving XY stage or a translational carriage (neither of which is shown) that moves the applicator 24 adjacent to the build area platform 12 in order to deposit the binding agent 36 or alloying agent 37 in predetermined areas of a layer of the metallic build material 16 that has been formed on the build area platform 12 in accordance with the method(s) disclosed herein. The applicator 24 may include a plurality of nozzles (not shown) through which the binding agent 36 and/or alloying agent 37 is to be ejected.

The applicator 24 may deliver drops of the binding agent 36 or alloying agent 37 at a resolution ranging from about 300 dots per inch (DPI) to about 1200 DPI. In other examples, the applicator 24 may deliver drops of the binding agent 36 or alloying agent at a higher or lower resolution. The drop velocity may range from about 2 m/s to about 24 m/s and the firing frequency may range from about 1 kHz to about 100 kHz. In one example, each drop may be in the order of about 10 picolitres (pl) per drop, although it is contemplated that a higher or lower drop size may be used. For example, the drop size may range from about 1 pl to about 400 pl. In some examples, applicator 24 is able to deliver variable size drops of the binding agent 36 or alloying agent 37.

Each of the previously described physical elements may be operatively connected to a controller 28 of the printing system 10. The controller 28 may control the operations of the build area platform 12, the build material supply 14, the build material distributor 18, and the applicator 24. As an example, the controller 28 may control actuators (not shown) to control various operations of the 3D printing system 10 components. The controller 28 may be a computing device, a semiconductor-based microprocessor, a central processing unit (CPU), an application specific integrated circuit (ASIC), and/or another hardware device. Although not shown, the controller 28 may be connected to the 3D printing system components via communication lines.

The controller 28 manipulates and transforms data, which may be represented as physical (electronic) quantities within the printer's registers and memories, in order to control the physical elements to create the metallic part 50. As such, the controller 28 is depicted as being in communication with a data store 30. The data store 30 may include data pertaining to a metallic part 50 to be printed by the 3D printing system 10. The data for the selective delivery of the metallic build material particles 16 and the binding agent 36 and/or alloying agent 37 may be derived from a model of the metallic part 50 to be formed. For instance, the data may include the locations on each layer of metallic build material particles 16 that the applicator 24 is to deposit the binding agent 36 and/or alloying agent 37. In one example, the controller 28 may use the data to control the applicator 24 to selectively apply the binding agent 36 and/or alloying agent 37. The data store 30 may also include machine readable instructions (stored on a non-transitory computer readable medium) that are to cause the controller 28 to control the amount of metallic build material particles 16 that is supplied by the build material supply 14, the movement of the build area platform 12, the movement of the build material distributor 18, or the movement of the applicator 24.

As shown in FIG. 1, the printing system 10 may also include a heater 32. In some examples, the heater 32 includes a conventional furnace or oven, a microwave, or devices capable of hybrid heating (i.e., conventional heating and microwave heating). This type of heater 32 may be used for heating the entire build material cake 44 (see FIG. 2E) after the printing is finished or for heating the patterned 3D printed object 42.

In some examples, patterning may take place in the printing system 10, and then the build material platform 12 with the patterned 3D printed object 42 thereon may be detached from the system 10 and placed into the heater 32 for the various heating stages. In other examples, the heater 32 may be a conductive heater or a radiative heater (e.g., infrared lamps) that is integrated into the system 10. These other types of heaters 32 may be placed below the build area platform 12 (e.g., conductive heating from below the platform 12) or may be placed above the build area platform 12 (e.g., radiative heating of the build material layer surface). Combinations of these types of heating may also be used. These other types of heaters 32 may be used throughout the 3D printing process. In still other examples, the heater 32′ may be a radiative heat source (e.g., a curing lamp) that is positioned to heat each layer 34 (see FIG. 2C) after the binding agent 36 and/or alloying agent 37 has been applied thereto. In the example shown in FIG. 1, the heater 32′ is attached to the side of the applicator 24, which allows for printing and heating in a single pass. In some examples, both the heater 32 and the heater 32′ may be used.

Referring now to FIGS. 2A through 2F, an example of the 3D printing method is depicted. Prior to execution of printing, the controller 28 may access data stored in the data store 30 pertaining to a metallic part that is to be printed. The controller 28 may determine the number of layers of metallic build material particles 16 that are to be formed, and the locations at which binding agent 36 and/or alloying agent 37 from the applicator 24 is to be deposited on each of the respective layers.

In FIG. 2A, the build material supply 14 may supply the metallic build material particles 16 into a position so that they are ready to be spread onto the build area platform 12. In FIG. 2B, the build material distributor 18 may spread the supplied metallic build material particles 16 onto the build area platform 12. The controller 28 may execute control build material supply instructions to control the build material supply 14 to appropriately position the metallic build material particles 16, and may execute control spreader instructions to control the build material distributor 18 to spread the supplied metallic build material particles 16 over the build area platform 12 to form a layer 34 of metallic build material particles 16 thereon. As shown in FIG. 2B, one layer 34 of the metallic build material particles 16 has been applied.

The layer 34 has a substantially uniform thickness across the build area platform 12. In an example, the thickness of the layer 34 ranges from about 30 microns to about 300 microns, although thinner or thicker layers may also be used. For example, the thickness of the layer 34 may range from about 20 microns to about 500 microns. The layer thickness may be about 2× the particle diameter (as shown in FIG. 2B) at a minimum for finer part definition. In some examples, the layer thickness may be about 1.2× (i.e., 1.2 times) the particle diameter.

Referring now to FIG. 2C, selectively applying the binding agent 36 and/or alloying agent 37 at selected locations on a portion 38 of the metallic build material 16 continues. As illustrated in FIG. 2C, the binding agent 36 and alloying agent 37 may be dispensed from the applicator 24. The applicator 24 may be a thermal inkjet printhead a piezoelectric printhead, or a continuous inkjet printhead, and the selectively applying of the binding agent 36 and/or alloying agent 37 may be accomplished by the associated inkjet printing technique. As such, the selectively applying of the binding agent 36 and/or alloying agent 37 may be accomplished by thermal inkjet printing or piezo electric inkjet printing.

The controller 28 may execute instructions to control the applicator 24 (e.g., in the directions indicated by the arrow 26) to deposit the binding agent 36 and/or alloying agent 37 onto predetermined portion(s) 38 of the metallic build material 16 that are to become part of a patterned 3D printed object 42 and are to ultimately be sintered to form the metallic part 50. The applicator 24 may be programmed to receive commands from the controller 28 and to deposit the binding agent 36 and/or alloying agent 37 according to a pattern of a cross-section for the layer of the metallic part 50 that is to be formed. As used herein, the cross-section of the layer of the metallic part 50 to be formed refers to the cross-section that is parallel to the surface of the build area platform 12. In the example shown in FIG. 2C, the applicator 24 selectively applies the binding agent 36 and/or alloying agent 37 on those portion(s) 38 of the layer 34 that are to be fused to become the first layer of the metallic part 50. As an example, if the 3D part that is to be formed is to be shaped like a cube or cylinder, the binding agent 36 will be deposited in a square pattern or a circular pattern (from a top view), respectively, on at least a portion of the layer 34 of the metallic build material particles 16.

In some examples, where it is desirable to modify the mechanical properties at region(s) of the 3D part, the alloying agent 37 can be deposited at predetermined locations on the build material so that the alloying agent can be incorporated into the final metal part in a first region/s (not shown). The alloying agent 37 may be applied to areas where the binding agent 36 is absent. For example, the binding agent 36 may be applied to delineate the regions where the alloying agent 37 is or is to be applied. Alternatively, the binding agent 36 and alloying agent 37 may both be applied to at least part of first region/s. Here, the first region/s will be formed by both the binding agent 36 and the alloying agent 37.

When the binding agent 36 and/or alloying agent 37 is selectively applied in the targeted portion(s) 38, the binder and/or marker infiltrate the inter-particles spaces among the metallic build material particles 16. The volume of the binding agent 36 and/or alloying agent 37 that is applied per unit of metallic build material 16 in the patterned portion 38 may be sufficient to fill a major fraction, or most of the porosity existing within the thickness of the portion 38 of the layer 34.

It is to be understood that portions 40 of the metallic build material 16 that do not have the binding agent 36 and/or alloying agent 37 applied thereto may not become part of the patterned 3D printed object 42 that is ultimately formed.

The processes shown in FIGS. 2A through 2C may be repeated to iteratively build up several patterned layers and to form the patterned 3D printed object 42′ (see FIG. 2E). At least one of the layers may be devoid of one of the alloying agent 37 or the binding agent 36. For example, the alloying agent 37 may only be present at selected locations of some of the layers and these layers will determine the locations of the first (alloyed) region/s.

FIG. 2D illustrates the initial formation of a second layer of metallic build material 16 on the layer 34 patterned with the binding agent 36 and/or alloying agent 37 In FIG. 2D, following deposition of the binding agent 36 and/or alloying agent onto predetermined portion(s) 38 of the layer 34 of metallic build material 16, the controller 28 may execute instructions to cause the build area platform 12 to be moved a relatively small distance in the direction denoted by the arrow 20. In other words, the build area platform 12 may be lowered to enable the next layer of metallic build material 16 to be formed. For example, the build material platform 12 may be lowered a distance that is equivalent to the height of the layer 34. In addition, following the lowering of the build area platform 12, the controller 28 may control the build material supply 14 to supply additional metallic build material 16 (e.g., through operation of an elevator, an auger, or the like) and the build material distributor 18 to form another layer of metallic build material particles 16 on top of the previously formed layer 34 with the additional metallic build material 16. The newly formed layer may be patterned with binding agent 36 and/or alloying agent 37.

Referring back to FIG. 2C, the layer 34 may be exposed to heating using heater 32′ after the binding agent 36 and/or alloying agent is applied to the layer 34 and before another layer is formed. The heater 32′ may be used to produce a stabilized or bound layer. Where a hydrated metal salt is used as the binder in the binding agent 36, heating to form the 3D printed object layer may take place at a temperature that is capable of dehydrating the hydrated metal salt, but that is not capable of melting or sintering the metallic build material 16. In this example, the processes shown in FIGS. 2A through 2C (including the heating of the layer 34) may be repeated to iteratively build up several layers and to produce the 3D printed object 42. The patterned 3D printed object 42 can then be exposed to the processes described in reference to FIG. 2F.

It will be understood that the heaters 32, 32′ can be one or both or a combination of overhead lamp(s) and/or lamps attached to moving carriage(s) (not all options are shown in the figures).

The cycle time when printing layer-by-layer can range from about 5 seconds to about 100 seconds. During this time a layer of metallic build material 34 is formed, binding agent 36 and/or alloying agent 37 is delivered to the layer, and heaters 32, 32′ heat the surface of the build material to a temperature that fuses the metallic build material by evaporating fluids from the agent and dehydrating the hydrated metal salt in the patterned 3D printed object 42.

In some examples, layers of metallic build material 16 and binding agent 36 and/or alloying agent 37 can be heated layer-by-layer, every two layers, every three layers, or so forth, or once the build material cake 44 has been fully formed to then form the patterned 3D printed object 42.

Repeatedly forming and patterning new layers (without curing each layer) results in the formation of a build material cake 44, as shown in FIG. 2E, which includes the patterned 3D printed object 42 residing within the non-patterned portions 40 of each of the layers 34 of metallic build material 16. The patterned 3D printed object 42 is a volume of the build material cake 44 that is filled with the metallic build material 16 and the binding agent 36 and/or alloying agent 37 within the inter-particle spaces. The remainder of the build material cake 44 is made up of the non-patterned metallic build material 16.

Also as shown in FIG. 2E, the build material cake 44 may be exposed to heat or radiation to generate heat, as denoted by the arrows 46. The heat applied may be sufficient to produce a stabilized and 3D printed object 42. In one example, the heat source 32 may be used to apply the heat to the build material cake 44. In the example shown in FIG. 2E, the build material cake 44 may remain on the build area platform 12 while being heated by the heat source 32. In another example, the build area platform 12, with the build material cake 44 thereon, may be detached from the applicator 24 and placed in the heat source 32. Any of the previously described heat sources 32 and/or 32′ may be used.

In the example where the build material cake is exposed to heat or radiation to generate heat, the length of time at which the heat 46 is applied to the build material cake and the rate at which the patterned 3D printed object 42 is heated may be dependent, for example, on: characteristics of the heat or radiation source 32, 32′, characteristics of the binder, characteristics of the metallic build material 16 (e.g., metal type or particle size), and/or the characteristics of the metallic part 50 (e.g., wall thickness). The patterned 3D printed object 42 may be heated at the dehydration temperature for a time period ranging from about 1 minute to about 360 minutes. In an example, this time period is about 30 minutes. In another example, this time period may range from about 2 minutes to about 240 minutes. The patterned 3D printed object 42 may be heated to the dehydration temperature at a rate of about 1° C./minute to about 10° C./minute, although it is contemplated that a slower or faster heating rate may be used. The heating rate may depend, in part, on: the binding agent 36 and/or alloying agent 37 used, the size (i.e., thickness and/or area (across the x-y plane)) of the layer 34 of metallic build material 16, and/or the characteristics of the metallic part 50 (e.g., size or wall thickness).

Heating a patterned 3D printed metal layer or object 42 can cause the binding agent 36 and/or alloying agent 37 to bind or coalesce into a continuous phase among the metallic build material particles 16 of the patterned 3D printed object 42. The continuous phase may act as an adhesive between the metallic build material particles 16 to form the stabilized, the patterned 3D printed metal layer or object 42.

Heating may also result in the evaporation of a significant fraction and in some instances all of the fluid from the patterned 3D printed metal layer or object 42. The evaporated fluid may include any of the binding or alloying agent components. Fluid evaporation may result in some densification, through capillary action, of the 3D printed object 42.

The stabilized, 3D printed object 42 exhibits handleable mechanical durability. The 3D printed object 42 may then be extracted from the build material cake 44. The 3D printed object 42 may be extracted by any suitable means. In an example, the 3D printed object 42 may be extracted by lifting the 3D printed object 42 from the unpatterned metallic build material particles 16. An extraction tool including a piston and a spring may be used.

When the 3D printed object 42 is extracted from the build material cake 44, the 3D printed object 42 may be removed from the build area platform 12 and placed in a heating mechanism. The heating mechanism may be the heater 32. In some examples, the 3D printed object 42 may be cleaned to remove unpatterned metallic build material particles 16 from its surface. In an example, the 3D printed object 42 may be cleaned with a brush and/or an air jet. Other examples of cleaning procedures include rotary tumbling or vibratory agitation in the presence of low density tumbling media, ultrasonic agitation in a liquid, or bead blasting.

After the extraction and/or the cleaning of the 3D printed object 42, may be treated e.g. by heating in various stages and then sintered to form the final metallic part 50, also as shown in FIG. 2F. Prior to sintering, heating may be performed e.g. to decompose the binder prior. For instance, where a polymer binder is employed, the polymer may be decomposed by heating and by products removed prior to sintering. Where a metal salt binder is employed, the binder may be decomposed by heating, leaving metallic portion within the part. The heating cycle may be tailored to e.g. the binder and build materials employed.

Heating to sinter is accomplished at a sintering temperature that is sufficient to sinter the remaining metallic build material particles 16. The sintering temperature is highly dependent upon the composition of the metallic build material particles 16.

The sintering heating temperature may also depend upon the particle size and time for sintering (i.e., high temperature exposure time). As an example, the sintering temperature may range from about 450° C. to about 1500° C. In another example, the sintering temperature is at least 900° C. An example of a sintering temperature for bronze is about 850° C., and an example of a sintering temperature for stainless steel is about 1300° C. While these temperatures are described as sintering temperature examples, it is to be understood that the sintering heating temperature depends upon the metallic build material 16 that is utilized, and may be higher or lower than the described examples. Heating at a suitable temperature sinters and fuses the metallic build material particles 16 to form a completed metallic part 50. For example, as a result of sintering, the density may go from 50% density to over 90%, and in some cases very close to 100% of the theoretical density.

The length of time at which the heat 52 for sintering is applied and the rate at which the part 42 is heated may be dependent, for example, on: characteristics of the heat or radiation source 32, characteristics of the binder and alloying agent, characteristics of the metallic build material 16 (e.g., metal type or particle size), and/or the target characteristics of the metallic part 50 (e.g., wall thickness).

The 3D printed object 42 may be heated to affect binding. This heating can be performed over a time period ranging from about 10 minutes to about 72 hours or from about 30 minutes to about 12 hours. In an example, the time period is 60 minutes. In another example, the time period is 180 minutes. The 3D printed object 42 may be heated at a rate ranging from about 0.5° C./minute to about 20° C./minute.

After binding, the 3D printed object 42 may be heated at the sintering temperature for a sintering time period ranging from about 20 minutes to about 15 hours. In an example, the sintering time period is 240 minutes. In another example, the sintering time period is 360 minutes. The at least substantially hydrated metal salt free 3D printed object 42 may be heated to the sintering temperature at a rate ranging from about 1° C./minute to about 20° C./minute. In an example, the 3D printed object 42 is heated to the sintering temperature at a rate ranging from about 10° C./minute to about 20° C./minute. A high ramp rate up to the sintering temperature may be useful to produce a more favorable grain structure or microstructure. However, in some instances, slower ramp rates may be useful. As such, in another example, the 3D printed object 42 may be heated to the sintering temperature at a rate ranging from about 1° C./minute to about 3° C./minute. In yet another example, the 3D printed object 42 may be heated to the sintering temperature at a rate of about 1.2° C./minute. In still another example, the 3D printed object 42 may be heated to the sintering temperature at a rate of about 2.5° C./minute.

In some examples, the heat 52 for sintering is applied in an environment containing an inert gas, a low reactivity gas, a reducing gas, or a combination thereof.

The sintering may be accomplished in an environment containing an inert gas, a low reactivity gas, and/or a reducing gas so that the metallic build material 16 will sinter rather than undergoing an alternate reaction (e.g., an oxidation reaction) which would fail to produce the metallic part 50. Examples of inert gas include but are not limited to argon gas, or helium gas. An example of a low reactivity gas includes nitrogen gas, and examples of reducing gases include but are not limited to hydrogen gas, or carbon monoxide gas.

In some examples, the heat 52 for sintering is applied in an environment containing carbon in addition to an inert gas, a low reactivity gas, a reducing gas, or a combination thereof. The sintering may be accomplished in an environment containing carbon to reduce the partial pressure of oxygen in the environment and further prevent the oxidation of the metallic build material 16 during sintering. An example of the carbon that may be placed in the heating environment includes graphite rods. In other examples, a graphite furnace may be used.

In some examples, the heat 52 is applied in a low gas pressure or vacuum environment. The sintering may be accomplished in a low gas pressure or vacuum environment so that the continuous metal oxide phase thermally decomposes to the corresponding metal and/or to prevent the oxidation of the metallic build material 16. Moreover, sintering at the low gas pressure or under vacuum may allow for more complete or faster pore collapse, and thus higher density parts. However, vacuum may not be used during sintering when the metallic build material 16 (e.g., Cr) is capable of evaporating in such conditions. In an example, the low pressure environment is at a pressure ranging from about 1 E-6 Torr (1*10<6> Torr) to about 10 Torr.

Although not shown, the operations depicted in FIGS. 2E and 2F may be automated and the controller 28 may control the operations.

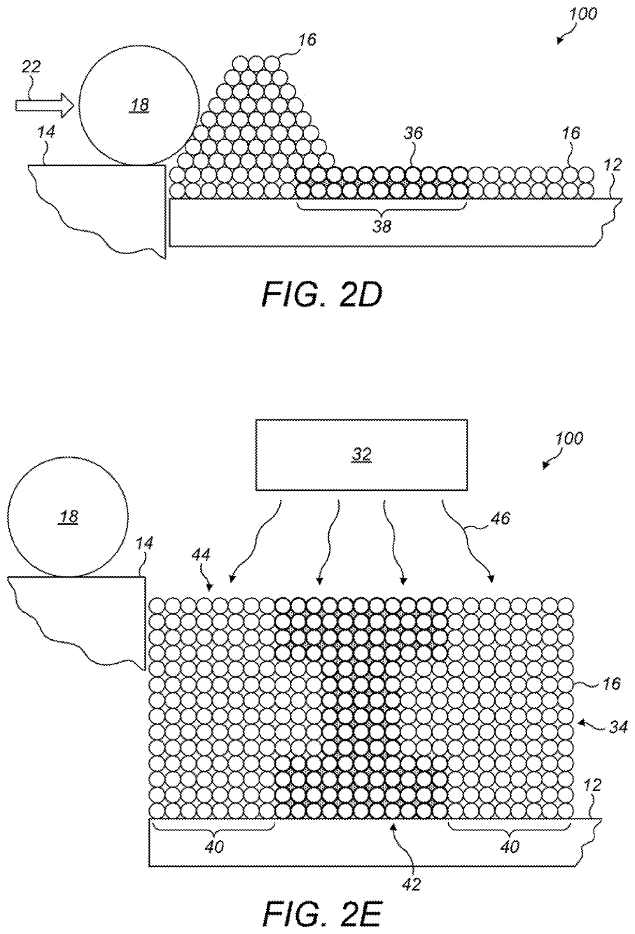

FIGS. 3 to 6 are schematic drawings that show examples of structures that can be printed using examples of the methods of the present disclosure. FIG. 3 depicts a structure (e.g. a microstructure) comprising regions of relatively higher ductility (second regions) interspersed with relatively stiffer regions (first regions). The relatively stiffer regions (first regions) are formed, for example, by an alloy of the alloying component and the metal of the build material. The regions of relatively higher ductility (second regions) may be formed of the build material. The stiffer first 210 are localized regions dispersed in a continuous matrix of more ductile second regions 212. The stiff zones 210 provide stiffness and strength to the structure (e.g. microstructure), while the ductile regions 212 reduce the risk of crack propagation. Thus, in the event of a fracture in a stiff region 210, crack propagation is limited by the softer nature of the ductile region 212. Overall, therefore, the structure can provide a desirable balance of strength and toughness.

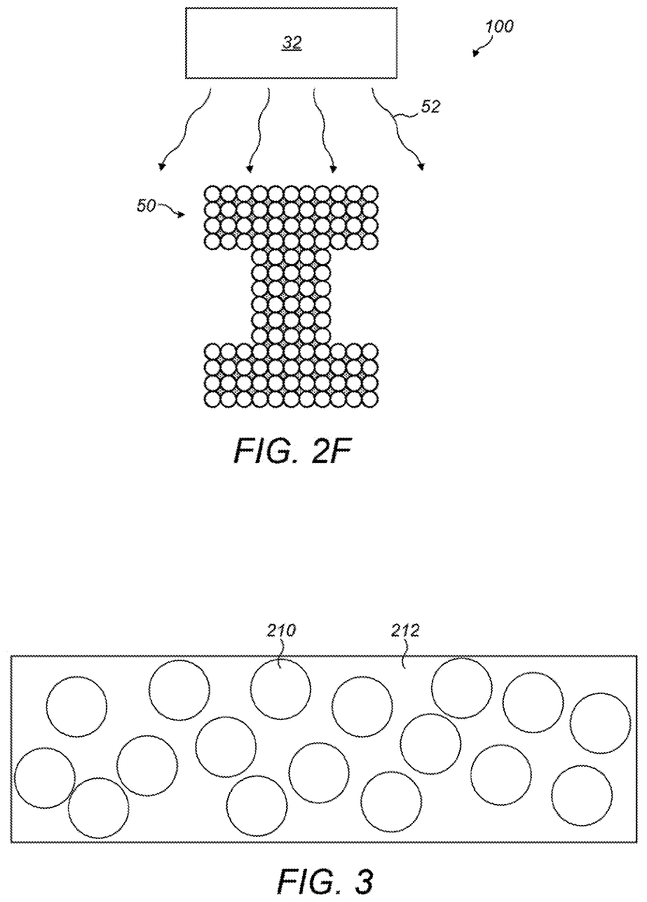

FIG. 4 shows an alternative structure (e.g. a microstructure) comprising regions of relatively higher ductility (second regions) interspersed with stiffer first regions formed of an alloy of the alloying component and the metal of the build material. In this example, the structure is a cellular structure (e.g. microstructure). The cell walls constitute the stiff first regions 210. The regions between the cell walls constitute the ductile second regions 212. In the event of a fracture in a stiff first region 210, crack propagation is limited by the softer nature of the ductile second region 212. Overall, therefore, the structure can provide a desirable balance of strength and toughness. In this example, the cells have a triangular shape. However, the cells may have any shape, for example, they may have a hexagonal shape.

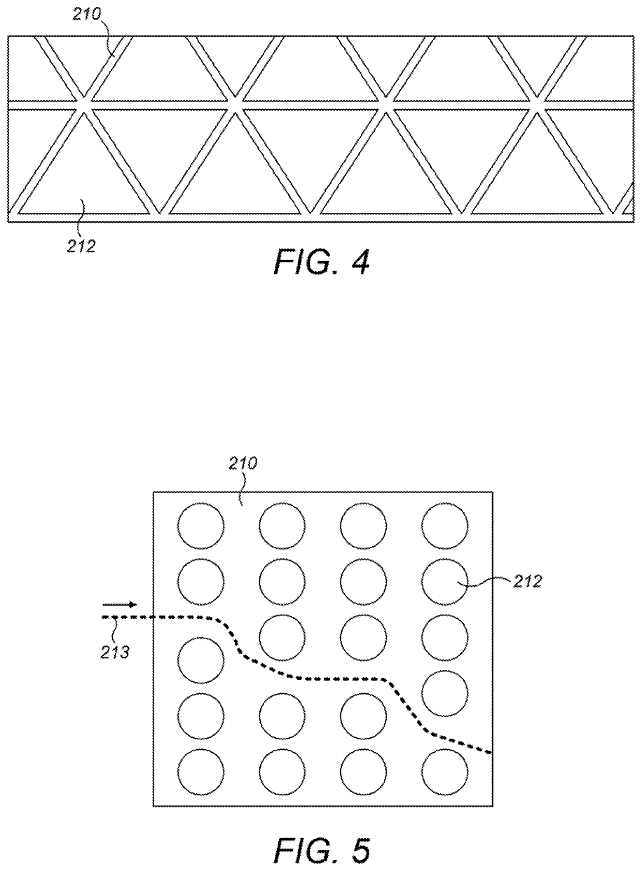

FIG. 5 shows an alternative structure comprising regions of relatively lower ductility (stiff zones) 210 interspersed by zones of relatively higher ductility (ductile zones). In this example, the ductile zones 212 provide a path 214 that provides controlled crack propagation.

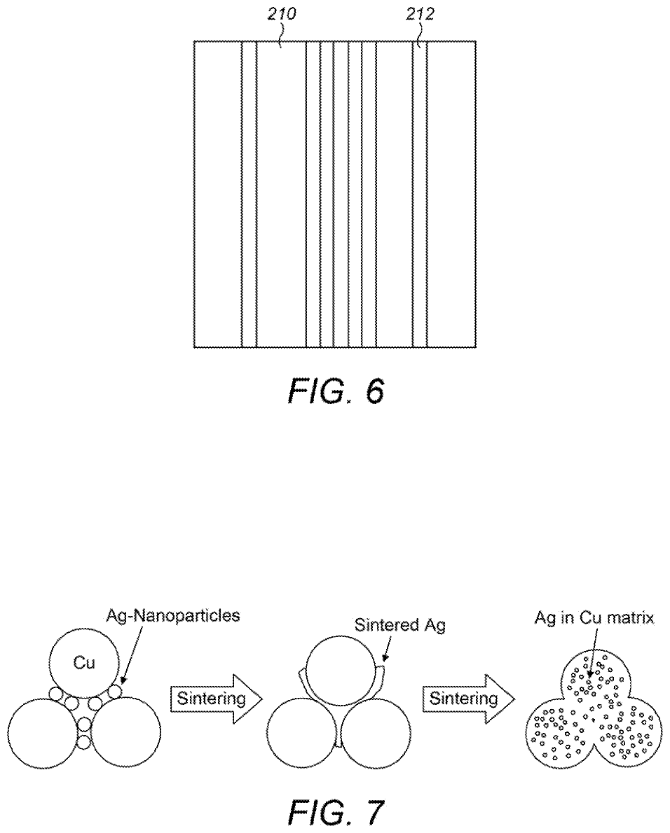

FIG. 6 shows yet another alternative laminated structure with alternating first (stiff) regions 210, and second (ductile) regions 212.

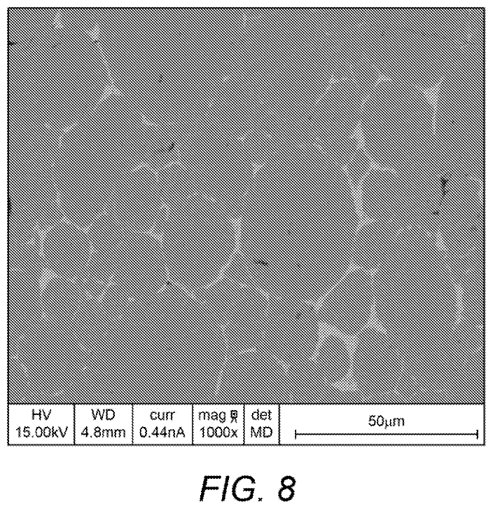

FIG. 7 is a schematic illustration of how an alloying component can be incorporated in the 3D printed metal object in a predetermined arrangement that comprises a first region comprising the alloying component, and how sintering can lead to the formation of an alloy of the alloying component and the metal of the build material. In the illustration shown in FIG. 7, the build material comprises copper particles 300, although it should be understood that other metal particles may also be employed. The alloying agent in this example comprises an alloying component in the form of silver nanoparticles 310. The silver nanoparticles 310 are selectively jetted onto the build material particles 300. During the printing process, the silver nanoparticles 310 penetrate the interstices between the copper particles 300. Upon sintering, the silver nanoparticles coalesce to at least partially coat the surface of the copper particles 300. However, upon further exposure to elevated sintering temperatures, the silver diffuses into the copper matrix to form an alloy of silver and copper. The build materials also densify to form a single solid body.

### Definitions

As used in the present disclosure, the term “about” is used to provide flexibility to an endpoint of a numerical range. The degree of flexibility of this term can be dictated by the particular variable and is determined based on the associated description herein.

Amounts and other numerical data may be expressed or presented herein in a range format. It is to be understood that such a range format is used merely for convenience and brevity and thus should be interpreted flexibly to include not just the numerical values explicitly recited as the limits of the range, but also to include individual numerical values or sub-ranges encompassed within that range as if each numerical value and sub-range is explicitly recited.

As used in the present disclosure, the term “comprises” has an open meaning, which allows other, unspecified features to be present. This term embraces, but is not limited to, the semi-closed term “consisting essentially of” and the closed term “consisting of”.

It is noted that, as used in this specification and the appended claims, the singular forms “a”, “an” and “the” include plural referents unless the context clearly dictates otherwise.

Where selective jetting of an agent is performed based on a 3D object model, the 3D object model may comprise at least one of: a 3D object model created using Computer Aided Design (CAD) or similar software; or a file, for example, a Standard Tessellation Language file generated based on output of the CAD software, providing one or more processors of a 3D printer with instructions to form the 3D object

### Example

In this Example, commercially available Ag nanoparticle ink (supplied by NovaCentrix®) was used to print 3D Cu parts. Sample Cu parts in a bar-shaped configuration, with dimensions 5×5×40 mm, were printed using an Ag ink printed at a carriage speed of 17 inches per second (ips). Ag loading is estimated to be 3 to 7 wt. % in the sintered part. The print bed was kept at 70° C. during the print. The green parts were sintered at 150° C., 250° C., 350° C., 450° C., 650° C., 950° C. and 1050° C. for 30 min in an inert atmosphere. The samples were sintered at various temperatures and photographs were taken of the sintered parts.

The part sintered at 1050° C. showed features of melting and solidification. Pure Cu melts at a ˜1083° C. This shows that the addition of nanoparticles caused a reduction in the melting point of Cu due to the alloying effect.

These sample green parts were tested for flexural strength. The sample parts sintered at 150° C. showed a break strength of about 3.5 MPa. Parts sintered at 250° C. showed a break strength of about 4.5 MPa. Parts sintered at 350° C. displayed significant improvement with a strength of about 13 MPa. The sample parts sintered above 450° C. withstood the maximum limit of the tester used, 50 N (˜18 MPa). Density measurements were carried out on the sintered parts using the Archimedes method, results are presented in table. 1

TABLE 1
Density of the sintered parts.

| Sintering temperature, | |
|---|---|
| Sintering time: 30 mins | Relative density % |
| 150 ± 10° C. | 48-50 |
| 250 ± 10° C. | 50-51 |
| 350 ± 10° C. | 50-51 |
| 450 ± 10° C. | 53-55 |
| 650 ± 10° C. | 55-58 |
| 950 ± 10° C. | 65-70 |
| 1050 ± 10° C. | 92-94 |

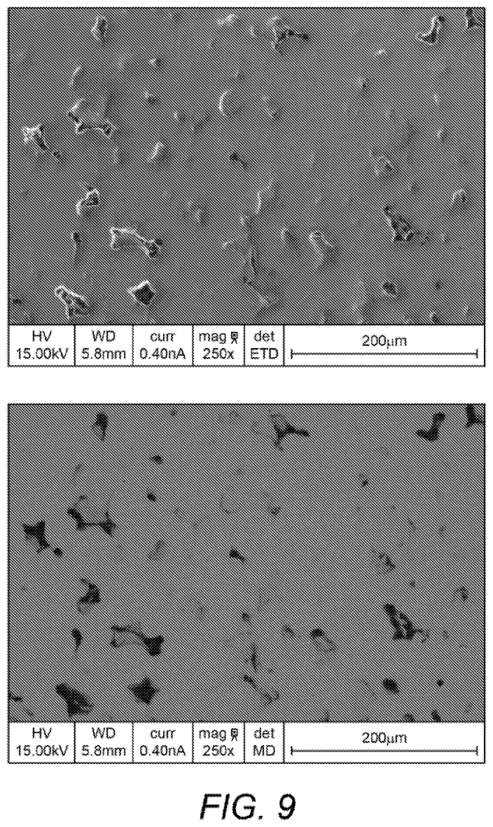

FIG. 8 shows the SEM-BSE image of the sample sintered at 650° C.-30 min in as-polished condition. The bright areas in SEM-BSE micrograph represent Ag-rich areas. A sintering temperature of 650° C. caused the nanoparticles to sinter and agglomerated together to several micron-sized networks. This Ag network of film surround the Cu particles and bind them together and provide part integrity.

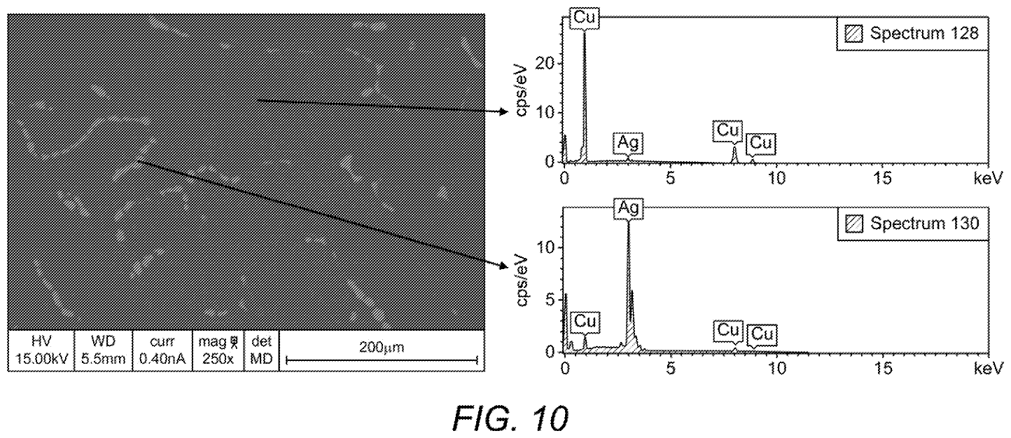

FIG. 9 shows the SEM-SE and BSE image of the cross-section surface of 950° C.-30 min sintered sample in as-polished condition (right hand image). SEM micrograph reveals more porous, and bumpy features compared to 650° C.-30 min sintered sample (left hand image). This phenomenon of increased porosity in the 950° C. sintered samples was attributed to transient liquid phase sintering. The Ag nanoparticles melt at the sintering temperature and form a molten layer surrounding the Cu particles. Since Ag is soluble in solid Cu, the molten Ag persists for a short duration of time and diffuses into Cu matrix, forming Cu—Ag alloy. When Ag diffuses into the copper matrix, it leaves behind a pore.

To confirm Ag nanoparticle melting, Ag ink was treated at 950° C. for 30 min in Nitrogen atmosphere. A high magnification SEM micrograph of an Ag globule was examined revealed dendritic mode of solidification.

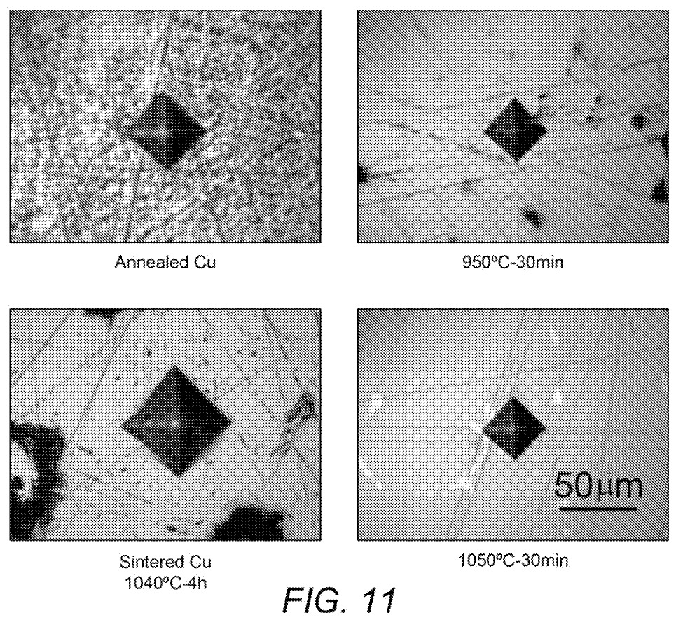

FIG. 10 shows the SEM-BSE image of the sample sintered at 1050° C.-30 min in as-polished condition. The brighter regions in SEM-BSE micrograph represent Ag rich areas, confirmed by EDS and mapping. The 1050° C. sintered sample show melting and solidification features with coarse dendritic arms and inter-dendritic segregation of Ag. According to the Cu—Ag phase diagram solid Cu dissolves up to 8% wt Ag and alternatively solid Ag dissolves up to 8.8% wt Cu. The composition percentage of Ag in Cu matrix and Cu in Ag networks (Table 2) were within the equilibrium limits of solubility of both the elements, indicating the presence of alpha and beta solid solution phases.

TABLE 2

| Element (wt %) | Spectrum 128 | Spectrum 130 |
|---|---|---|
| Cu | 94.19 | 7.69 |
| Ag | 5.81 | 92.31 |

### Microhardness Measurements

Vicker's microhardness of annealed Cu bar and sintered samples was measured, and the results are presenting in the table. 3. Optical micrographs of the microhardness-indentation are presented in FIG. 11 The indentation size on print-sintered samples was smaller than the pure Cu sample (annealed), which implies higher hardness in the alloyed regions of samples. Higher hardness is attributed to the solid solution-strengthening effect.

TABLE 3
Microhardness of annealed Cu and sintered samples.

| Sample | Microhardness, HV_{0.05} |
|---|---|
| Annealed Cu bar | 45-56 |
| Sintered Cu, 1040° C.-4 h | 38-60 |
| Cu—Ag ink, 950° C.-30 min | 75-92 |
| Cu—Ag ink, 1050° C.-30 min | 80-110 |

1. A kit for three-dimensional (3D) printing a 3D printed metal object, said kit comprising:
an alloying agent comprising an alloying component dispersed in a liquid carrier;
a binding agent comprising a binder dispersed in a liquid carrier; and
build material comprising a first metal that forms an alloy with the alloying component.

2. The kit according to claim 1, wherein the alloying component comprises a component selected from carbon and a second metal.

3. The kit according to claim 1, wherein the binder comprises a metal salt and/or a polymer binder.

4. The kit according to claim 3, wherein the binder comprises a salt of the first metal.

5. The kit according to claim 1, wherein the build material comprises a first metal that is selected from at least one of copper, iron, nickel, titanium, aluminium, cobalt and silver.

6. The kit according to claim 2, wherein the first metal is copper and the alloying component comprises silver.

7. The kit according to claim 2, wherein the first metal is iron and the alloying component comprises carbon and/or copper.

8. A method of three-dimensional (3D) printing a 3D printed metal object, said method comprising:
selectively jetting an alloying agent onto build material, wherein the build material comprises a first metal and the alloying agent comprises an alloying component that forms an alloy with the first metal;
selectively jetting a binding agent onto the build material; and
binding the build material to form a layer; such that the alloying component is incorporated in the 3D printed metal object in a predetermined arrangement that comprises a first region and a second region, wherein the first region comprises the alloying component and the second region is substantially free from the alloying component or comprises the alloying component at a lower concentration than the first regions.

9. The method according to claim 8, wherein the first region is adjacent to the second region.

10. The method according to claim 8, wherein, after binding, the build material is sintered to a temperature of at least 300 degrees C.

11. The method according to claim 10, wherein the alloying component is incorporated in the 3D printed metal object to form a structure comprising first regions interspersed by second regions, wherein the first regions comprise an alloy formed from the first metal and alloying component.

12. The method according to claim 11, wherein the first regions have a higher stiffness than the second regions.

13. A 3D printed metal structure formed from a first metal, said structure comprising first regions interspersed by second regions, wherein the first regions have a higher stiffness than the second regions, and wherein the first regions comprise an alloy of the first metal and an alloying component, and the second regions comprise the first metal.

14. The printed metal structure of claim 13, wherein the second regions are substantially free from the alloying component.

15. The printed metal structure according to claim 13, wherein the first metal is iron and/or copper.
